(19) United States
(12) Patent Application Publication
(10) Pub. No.: US 2024/0317023 A1
(43) Pub. Date: Sep. 26, 2024

(54) VEHICLE VENT

(71) Applicant: ANTOINE BOURQUE, FOXBORO (CA)

(72) Inventor: ANTOINE BOURQUE, FOXBORO (CA)

(21) Appl. No.: 18/606,530

(22) Filed: Mar. 15, 2024

Related U.S. Application Data
(60) Provisional application No. 63/454,503, filed on Mar. 24, 2023.

(51) Int. Cl. B60H 1/26

(52) U.S. Cl. CPC B60H 1/26

(57) ABSTRACT

A vent for an enclosure of a vehicle for ventilating the enclosure via a hole in an exterior surface of the enclosure to atmosphere, the vent comprising: a flange portion for resting on the exterior surface of the enclosure, the flange portion having an opening for overlapping with the hole; one or more side portions extending from the flange portion to form an interior of the vent, the one or more side portions for maintaining a cap portion in a spaced apart relationship with the flange portion, the one or more side portions having a plurality of louvers for directing air with respect to the interior; the cap positioned over the flange portion for covering over the opening to provide for the interior, the cap portion having a pair of angled portions opposed to one another, the pair of angled portions for directing the air over the vent during travel of the vehicle; and a corrugated filter positioned in the interior and interposed transversely between the opening and the atmosphere, the corrugated filter plate providing for a passage of air between the atmosphere and the opening, the corrugated filter having a plurality of pores having a pore size sufficient for facilitating the air passage of air through the corrugated filter while blocking passage of atmospheric particles through the corrugated filter.

### CROSS-REFERENCE TO RELATED APPLICATION

This application claims the benefit of U.S. Provisional Application Ser. No. 63/454,503, filed Mar. 24, 2023, which is incorporated herein by reference in its entirety.

### FIELD

This disclosure relates generally to vents for venting a moving vehicle such as a trailer or train car.

### BACKGROUND

Vents provide the necessary ventilation to an enclosure, inhibiting condensation in the enclosure due to the infiltration or otherwise collection of moisture into the enclosure. Various vents employ vanes, grates and louvers to permit air to be channeled between the enclosure and the atmosphere, and to try to inhibit rain from entering the enclosure through the vent. A variety of caps and covers have been used to act as a guard to prevent the infiltration of rain. However, prior art vents have thus far been ineffective to account for different direction of travel for a vehicle, and thus to provide for appropriate ventilation for an enclosure of a vehicle, when travelling in different directions.

### SUMMARY

It is an object of the present invention to provide a vent that obviates or mitigates at least some of the above-presented disadvantages in the art.

An improved vent which facilitates adequate ventilation but at the same time inhibits the infiltration of snow particles, water droplets, water runoff of the roof surface, burning cinders, and/or other undesirable elements from the atmosphere from gaining entry into the enclosure via the vent is desired.

A first aspect provided is a vent for an enclosure of a vehicle for ventilating the enclosure via a hole in an exterior surface of the enclosure to atmosphere, the vent comprising: a flange portion for resting on the exterior surface of the enclosure, the flange portion having an opening for overlapping with the hole; one or more side portions extending from the flange portion to form an interior of the vent, the one or more side portions for maintaining a cap portion in a spaced apart relationship with the flange portion, the one or more side portions having a plurality of louvers for directing air with respect to the interior; the cap positioned over the flange portion for covering over the opening to provide for the interior, the cap portion having a pair of angled portions opposed to one another, the pair of angled portions for directing the air over the vent during travel of the vehicle; and a corrugated filter positioned in the interior and interposed transversely between the opening and the atmosphere, the corrugated filter plate providing for a passage of air between the atmosphere and the opening, the corrugated filter having a plurality of pores having a pore size sufficient for facilitating the air passage of air through the corrugated filter while blocking passage of atmospheric particles through the corrugated filter.

### BRIEF DESCRIPTION OF THE DRAWINGS

The foregoing and other aspects will now be described by way of example only with reference to the attached drawings, in which:

FIG. 1 is a perspective view of an assembled enclosure vent for a vehicle;

FIG. 2 is a bottom view of the vent shown in FIG. 1;

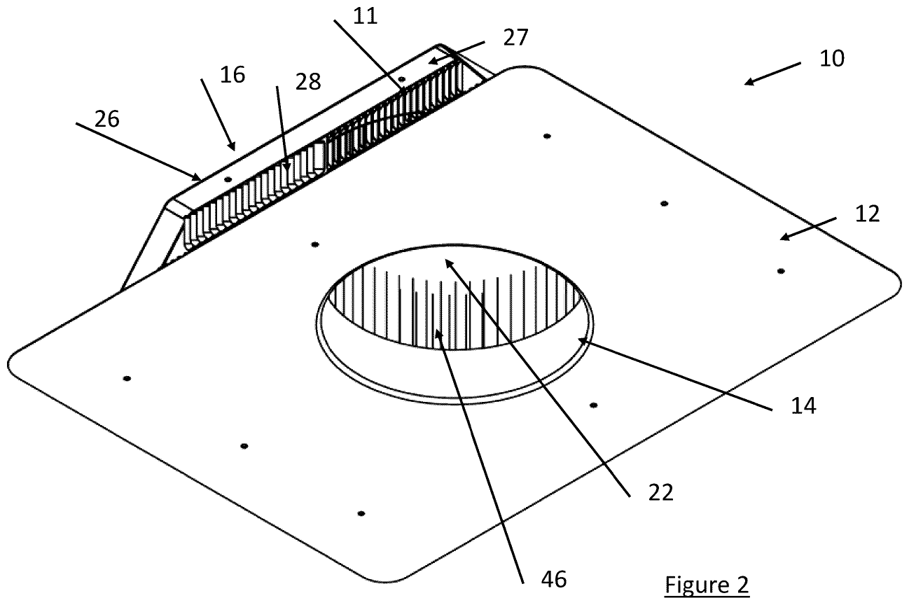

FIGS. 3a,b show views of side portions of roof vent shown in FIG. 1;

FIG. 4 an exploded view of the vent shown in FIG. 1;

FIG. 5 is an assembled view of the vent shown in FIG. 1 without the cap portion; and

FIG. 6 is a perspective view of a portion of the filter material of the filter shown in FIG. 4.

In the drawings like characters of reference indicate corresponding parts in the different figures.

### DETAILED DESCRIPTION

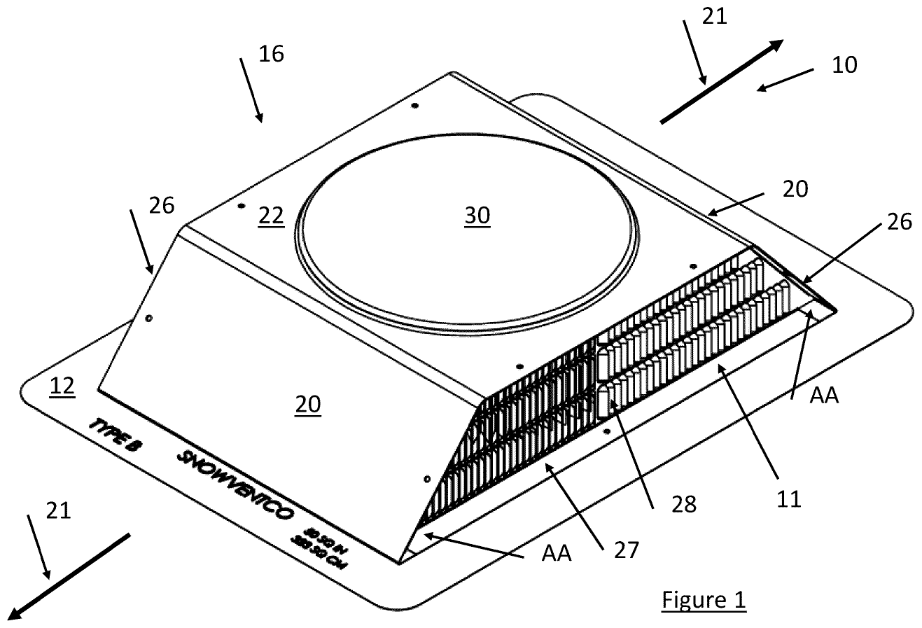

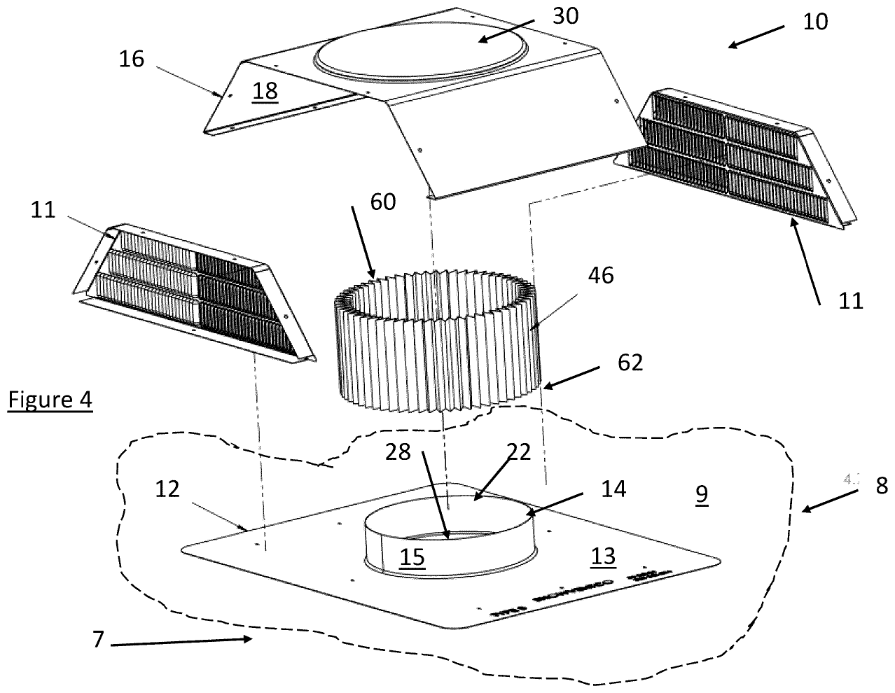

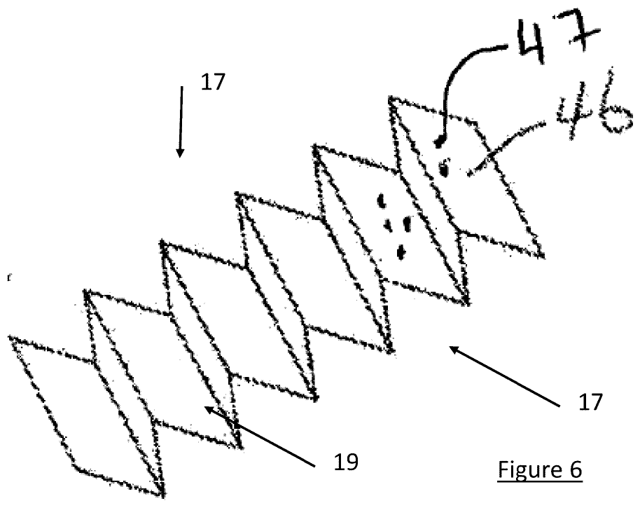

FIGS. 1, 4 show a vent 10 (e.g. enclosure vent) for ventilating an enclosure 7 (e.g. train car, transport truck trailer, etc.) of a vehicle 8 (shown in ghosted view) to the atmosphere. The vent 10 includes a flange portion 12 to lay against a roof 9 of the enclosure, the flange portion 12 having an opening 22 to let air vent from the interior of the enclosure (e.g. a train car). The vent 10 can optionally include a collar portion 14 extending from the flange portion 12 and enclosing, at least in part, about a periphery of the opening 22, and a cap portion 16 dimensioned and configured to cover over the opening 22 (including a hole 28 in the roof 8) and optionally over the collar portion 14. The cap portion 16 is configured to provide a passage (between the flange portion 12 and the cap portion 16) through side portions 11, further described below, which air can pass between the atmosphere and the opening 22 via the vent 10. The vent 10 also includes a corrugated filter plate 46, e.g. partially enclosed by the cap 16, and interposed between the central opening 22 and the air passage (e.g. gap) through the side portions 11 between the cap 16 and the flange portion 12. The corrugated filter 46 can have a pore size 47 (e.g. perforations, holes, a plurality of apertures/pores 47, etc.—see FIG. 6, recognizing that a surface 19 of the filter material 46 would be covered in the plurality of apertures 47) sufficient to facilitate air to pass through the corrugated filter material 46 (e.g. from one side 17 of the corrugated filter material 46 to the other 17) but inhibit the passage of precipitation particles, cinder particles and/or condensate droplets there-through (e.g. from one side 17 of the corrugated filter material 46 to the other 17). In any event, it is recognized that the purpose of the corrugated filter material 46 is to provide for the flow through of air while inhibiting the passage of undesirable particles/droplets (e.g. solid and/or liquid pieces of matter) through the corrugated filter material 46 impinging from the atmosphere and into the interior of the enclosure via the opening 22 and adjacent hole 28. It is recognised that the vent 10 can be positioned on a roof of the vehicle 8 and/or on a side of the vehicle 8, so long as each of the angled portions 20 are facing a respective one of the travel directions 21a,b.

For example, referring to FIG. 4, the corrugated filter material 46 can be positioned as extending (e.g. upwardly) between the flange portion 12 and the cap 16 (covering the opening 22). It is recognized that the corrugated filter material 46 can be in contact with a top surface 13 of the flange portion 12, in contact with an underside surface 18 of the cap 16, and/or in contact with the top surface 13 of the flange portion 12 and with the underside surface 18 of the cap 16. It is recognized that a sidewall 15 (e.g. collar wall—see FIG. 4) extending away (e.g. upwardly) from the top surface 13 of the flange portion 12 can also be considered as part of the top surface 13 of the flange portion 12. It is recognized that a sidewall (not shown) extending downwardly from the bottom/underside surface 18 of the cap 16 can also be considered as part of the bottom/underside surface 18 of the cap 16.

Corrugated (see FIG. 6) can refer to draws or bends into folds or alternate furrows and ridges of the surface 19 of the filter material 46. A corrugated surface can also refer to a pleated surface 19. A corrugated surface 19 can also refer to a shape into folds or parallel and alternating ridges and grooves. The juncture between the folds can be well defined (e.g. a crease line) or can be distributed over the surface (e.g. an arcuate change in direction from one fold to the next, such as an arcuate portion of the surface 19 of the corrugated filter material 46). For example, the corrugated filter material 46 (e.g. circular filter) can be a single walled surface 19 as shown, can be a double walled structure, not shown, (e.g. having a space between adjacent walls having a corrugated surface 19, etc). Preferably the corrugated filter material 46 has a corrugated surface 19 exposed to the passage of air impinging on the corrugated filter material 46 from the atmosphere and directed towards the opening 22 (and overlapping hole 28 in the roof of the enclosure). Preferably the corrugated filter material 46 has a corrugated surface 19 exposed to the passage of air impinging on the corrugated filter material 46 from the exiting the enclosure and directed towards the opening 22 (and overlapping hole 28 in the roof of the enclosure) and into the atmosphere.

In terms of positioning of the corrugated filter material 46 with respect to the cap 16 (at least covering the opening 28) and with respect to the flange portion 12, the corrugated filter material 46 is positioned transverse to both of the cap 16 (e.g. underside surface 18 of the cap 16) and the flange portion 12 (e.g. upper surface 13 of the flange portion 12). As such, it is recognized that the corrugated filter material 46 can be in contact with one of the surfaces 13, 18, with both of the surfaces 13, 18, an/or in contact with none of the surfaces 13,18 (e.g. suspended between the surfaces 13,18 by a secondary structure that can also be used to position the cap 16 in a spaced apart relationship with the flange portion 12. For example, the secondary structure can be provided by the collar portion 14 described herein as an example only. In any event, the corrugated filter material 46 extends transversely (in whole, in part, etc.) between the cap 16 and the flange portion 12 (e.g. base of the vent 10). In terms of in-whole, then any passage of air between the opening 22 and the atmosphere would pass though the body of the corrugated filter material 46. Alternatively, in terms of in-part, some of the passage of air between the opening 22 and the atmosphere would pass though the body of the corrugated filter material 46 and passage of air between the opening 22 and the atmosphere would go around the body of the corrugated filter material 46. In terms of transverse, this can be referred to as situated or lying across (e.g. between the opposing surfaces 13,18), lying sideways (e.g. between the opposing surfaces 13,18), crosswise (e.g. between the opposing surfaces 13,18), crossing from side to side (e.g. between the opposing surfaces 13,18), athwart (e.g. between the opposing surfaces 13,18), crossways (e.g. between the opposing surfaces 13,18), lying or extending across or in a cross direction (e.g. between the opposing surfaces 13,18), cross (e.g. between the opposing surfaces 13,18). One example of transverse (e.g. between the opposing surfaces 13,18) can be lying at right angles to or perpendicular to each or both of the opposing surfaces 13,18). It is also recognized that the angle of the corrugated filter material 46, when extending away from (either in or out of contact with the actual surface 13,18) the surface 13,18, can be other than 90 degrees, as desired.

The vent 10 can be considered as a vent type for natural ventilation (stationary enclosure) and/or forced ventilation (moving enclosure), as using the process of supplying and removing air through an indoor space without using mechanical systems. Ventilation implemented by the vent 10 can refer to the flow of external air to an indoor space as a result of pressure or temperature differences. There can be two types of ventilation occurring: wind driven ventilation due to movement of the enclosure and buoyancy-driven ventilation. While wind can be the main mechanism of wind driven ventilation, buoyancy-driven ventilation can occur as a result of the directional buoyancy force that results from temperature differences between the interior and exterior of the enclosure.

In terms of the net free cross sectional area for the passage of air through the corrugated filter 46, the aggregate total open area (e.g. summation of the effective open area of each of the individual pore 47 cross sectional areas) of the plurality of holes/pores 47 can be configured to satisfy a minimum net open area threshold. For example, the open area threshold can be approximately 50 square inches of flow ability (e.g. net free area) available for the passage of air to flow through. It is recognized that the minimum net open area threshold can be a standard defined threshold, different for each country, province, and/or state based building codes/standards. In an example where the corrugated filter plate 46 does not extend from surface 13 to surface 18, the total net free air flow area available would be the aggregate of the effective open area of each of the individual pore 47 cross sectional areas of the corrugated filter 46 and the open cross sectional area of an air gap between an end of the filter 46 and the adjacent surface 13, 18.

One embodiment of the corrugated filter 46 can be a wire mesh which is corrugated to increase its surface area, thus providing for the passage of air through the surface 19 at a multiple of angles relating to the different surfaces of the folds that are angles to one another. As such, the corrugated surface 19 has a greater surface area as compared to a corresponding planar surface of a side portion(s) of the vent 10. The corrugated filter plate 46 can have a pore 47 size which is selected to inhibit the passage of atmospheric particles (e.g. snow/rain particles) through the corrugated filter pate 46, while facilitating the flow of air through the corrugated filter 46 from side 17 to side 17. For example, a pore size of approximately 120 microns can inhibit the passage of precipitation while providing for adequate air circulation through the corrugated surface of the filter 46, as compared to the planar surface area of a non-corrugated cross sectional area of the side portions of the vent 10. The material of the corrugated filter 46 can be composed of metal, such as but not limited to stainless steel, aluminum, or other materials that can inhibit attachment of the particles (e.g. snow) to the corrugated surface 19, when the surface 19 is in an extending orientation (e.g. upwardly, away from, towards, etc.) with respect to the surface(s) 13,18.

It is recognized that the corrugated filter 46 can be of any peripheral shape (e.g. about a periphery of the hole 28), for example square as shown in FIG. 4, as well as any other shape as desired (e.g. circular, oblong, triangular, rectangular, pentagonal), as well as any number of sides (e.g. a square has 4 sides, a triangle has three sides, etc.), as well as any side shape (e.g. linear, arcuate, etc.).

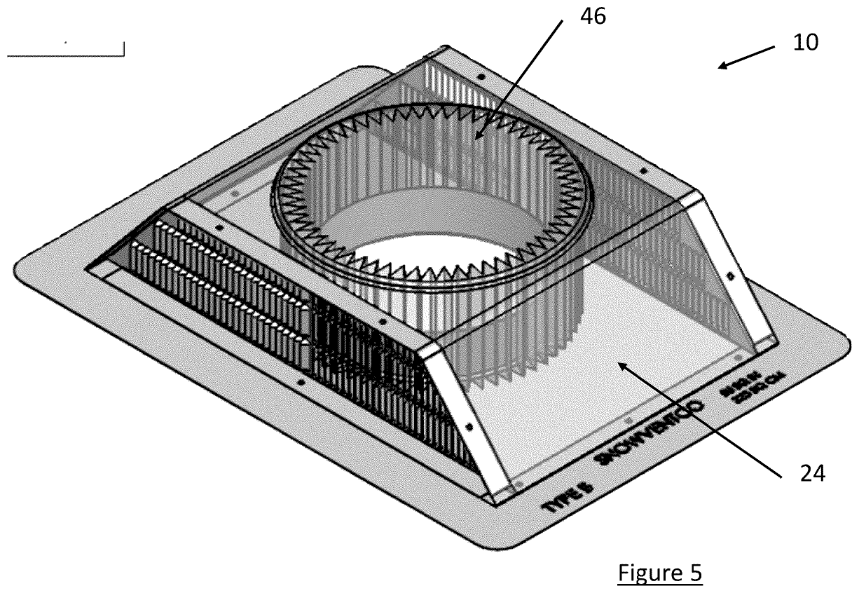

Referring to FIG. 1, show is the cap portion 16 of the vent 10. The cap portion 16 has a pair of angled portions 20 positioned opposite to one another, so as to be facing opposite travel directions 21 of the vehicle 8 (see FIG. 4). In this regard, the cap portion 16 has a pair of angled portions 20 opposed to one another, such that each angled portion 20 makes an acute angle AA with the flange portion 12. Also, the angled portions 20 are connected to one another by an intermediate portion 22 of the cap portion 16. For example, the intermediate portion 22 can be positioned in a spaced apart position with respect to the flange 12, in order to accommodate the positioning of the filter material 46 within a defined interior 24 (see FIG. 5) of the vent 10.

Referring again to FIG. 1, shown are the side portions 11 positioned as optionally indented (e.g. by an indent portion 27) from the side edges 26 of the cap portion 16. An advantage of the indent position is that the impinging air onto the vents 28 of the side portions 11 is deflected in part by the side edges 26, as the vent 10 is moved in the travel direction(s) 21. Further, the intermediate portion 22 can have a receptacle 30 for inserting one end 60 (see FIG. 4) of the filter material 46. Also, as shown, the collar 14 can be used to position the other end 62 of the filter material 46.

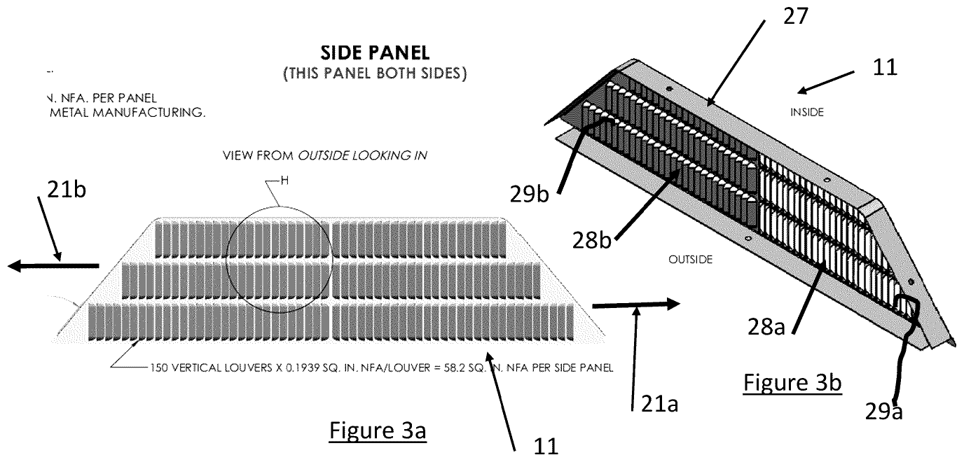

Referring to FIG. 3a, 3b, shown are different sides the side portion 11. It is recognized that the side portion 11 has a first set of vents 28a (e.g. louvers) and a second set of vents 28b, such that vent openings 29a of the first set of vents 28a are towards the first direction 21a and the vent openings 29b of the second set of vents 28b are towards the second directions 21b. this is advantageous as when travelling in the respective direction 21a,b, the openings 29a,b are oriented such that they direct air into the enclosure 7 (see FIG. 4) for their respected travel direction 21a,b.

Referring to FIG. 5, shown is the vent 10 without the cap portion 16, thus showing the interior 24 with the positioned filter material 46.

In view of the above, it is recognized that the vent 10 can have the following physical properties and geometries:
a) a double slant provided by the angles AA, therefor advantageously providing angled portions 20 positioned back to back on the vent 10 so that no matter which direction 21a,b the vehicle 8 travels, the respective slant portion 20 deflects the onrushing wind.
b) indented side panels 11 for wind protection;
c) grill openings 29a,b slanted towards their respective travel direction 21a,b to facilitate air movement/draw during movement of the vehicle 8; and
d) uses a kilted filter material 46.

Further, it is recognized that the vent 10 has the angled portions 20 as forward/rearward facing inclined faces having an absence of louvers/openings so as to deflect air up and over/around the vent cap portion 16 during travel of the vehicle 8. Further, the vents 28a,b (also referred to as louvers) on all of the side portions 11 can be bent outwards (e.g. away from the interior 24) rather than inwards.

As such, the vent 10 for an enclosure of a vehicle 8 for ventilating the enclosure 7 via a hole 28 in an exterior surface 9 of the enclosure 7 to atmosphere, the vent 10 comprising: a flange portion 12 for resting on the exterior surface 9 of the enclosure 7, the flange portion 12 having an opening 22 for overlapping with the hole 28; one or more side portions 11 (e.g. a pair) extending from the flange portion 12 to form an interior 24 of the vent 10, the one or more side portions 11 for maintaining a cap portion 16 in a spaced apart relationship with the flange portion 12, the one or more side portions 11 having a plurality of louvers 28a,28b for directing air with respect to the interior 24; the cap portion 16 positioned over the flange portion 12 for covering over the opening 22 to provide for the interior 24, the cap portion 16 having a pair of angled portions 20 opposed to one another, the pair of angled portions 20 for directing the air over the vent 10 during travel of the vehicle 8; and a corrugated filter 46 positioned in the interior 24 and interposed transversely between the opening 22 and the atmosphere, the corrugated filter 46 providing for a passage of air between the atmosphere and the opening 22, the corrugated filter 46 having a plurality of pores 47 having a pore size sufficient for facilitating the air passage of air through the corrugated filter 46 while blocking passage of atmospheric particles through the corrugated filter 46.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A vent for an enclosure of a vehicle for ventilating the enclosure via a hole in an exterior surface of the enclosure to atmosphere, the vent comprising:
a flange portion for resting on the exterior surface of the enclosure, the flange portion having an opening for overlapping with the hole;
one or more side portions extending from the flange portion to form an interior of the vent, the one or more side portions for maintaining a cap portion in a spaced apart relationship with the flange portion, the one or more side portions having a plurality of louvers for directing air with respect to the interior;
the cap positioned over the flange portion for covering over the opening to provide for the interior, the cap portion having a pair of angled portions opposed to one another, the pair of angled portions for directing the air over the vent during travel of the vehicle; and
a corrugated filter positioned in the interior and interposed transversely between the opening and the atmosphere, the corrugated filter providing for a passage of air between the atmosphere and the opening, the corrugated filter having a plurality of pores having a pore size sufficient for facilitating the air passage of air through the corrugated filter while blocking passage of atmospheric particles through the corrugated filter.

2. The vent of claim 1, wherein each of the pair of angled portions makes a respective acute angle with the flange portion.

3. The vent of claim 1 further comprising an intermediate portion of the cap portion, the intermediate portion positioned between the pair of angled portions.

4. The vent of claim 1 wherein the plurality of louvers has a first vent portion and a second vent portion, such that first openings of the first vent portion are directed opposite to second openings of the second vent portion.

5. The vent of claim 1, wherein the flange portion is for positioning on a roof of the enclosure.

6. The vent of claim 1, wherein the corrugated filter has a corrugated surface having a series of alternating folds, a plurality of the series of alternating folds having the plurality of pores.

7. The vent of claim 1, wherein the at least one side portion is indented by an indent portion from a side edge of the cap portion, said indented is towards the interior.
